(19) United States
(12) Patent Application Publication
(10) Pub. No.: US 2011/0194297 A1
(43) Pub. Date: Aug. 11, 2011

(54) LED LAMP ASSEMBLY

(76) Inventor: CHIA-YEH WU, HSINCHU CITY (TW)

(21) Appl. No.: 12/772,341

(22) Filed: May 3, 2010

(30) Foreign Application Priority Data
Feb. 11, 2010 (TW) 099104369

(51) Int. Cl. F21V 29/00; F21V 15/01

(52) U.S. Cl. 362/373; 362/362

(57) ABSTRACT

The present invention discloses a LED lamp assembly, which comprises a lamp casing having a set of separator fixing protrusions arranged on the inner surface thereof and a set of panel fixing protrusions arranged on the inner surface thereof and below the separator fixing protrusions; a lamp fixing separator arranged inside the lamp casing and used to fix LED lamps, wherein the rim of the lamp fixing separator is fixed to the separator fixing protrusions; and a panel arranged inside the lamp casing and having at least one opening allowing the bottoms of the

LED lamps to pass, wherein the rim of the panel is fixed to the panel fixing protrusions. In the present invention, the breakdown LED lamp can be easily replaced; the lamp fixing separator and the panel can be easily disassembled to maintain the power cord.

### BACKGROUND OF THE INVENTION

1. Field of the Invention

The present invention relates to an illuminator, particularly to a LED lamp assembly.

2. Description of the Related Art

Facing serious energy overuse, how to reduce energy consumption has become the most important global problem. Street light is a fundamental public construction and is also an important source of energy consumption. The conventional street lights usually adopt incandescent lamps, halogen lamps, fluorescent lamps and mercury lamps, which are energy-inefficient and massively consume energy. LED (Light-Emitting

Diode) has advantages of fast response, long service life, low power consumption, and high energy efficiency. Therefore, it has been a trend of energy saving and environmental protection to adopt LED as the light source of street lights.

The conventional LED lamp structure for a street light usually comprises a lamp casing; a light-permeable panel arranged on the opening of the lamp casing; a substrate arranged between the lamp casing and the light-permeable panel. The substrate has several LED chips and a LED driving circuit. When LED chips emit light, the light passes through the light-permeable panel to illuminate the environment. However, the whole substrate must be dismounted and replaced even if only a single LED chip malfunctions. Therefore, the conventional technology has higher maintenance cost, wastes material, and conflicts with the idea of environmental protection.

The commercially available Hi-Power LED lamp (HP LED for short) is installed on an aluminum substrate. The heat generated by HP LED is dissipated by the aluminum substrate and the alloy fins installed below the aluminum substrate. However, the aluminum substrate and the alloy fins are heavy and bulky. Thus, the current HP LED is weighty, space-inefficient and expensive.

Accordingly, the present invention proposes a novel LED lamp assembly to overcome the abovementioned problems.

### SUMMARY OF THE INVENTION

The primary objective of the present invention is to provide a LED (Light-Emitting Diode) lamp assembly, wherein the breakdown LED lamp can be easily disassembled and replaced via screwing the lamp head out of the lamp seat without replacing the entire substrate, whereby the present invention has advantages of easy maintenance and low cost.

Another objective of the present invention is to provide a LED lamp assembly, wherein the lamp fixing separator and the panel can be easily disassembled via screwing out the screws, whereby the power cord can be conveniently maintained.

Yet another objective of the present invention is to provide a LED lamp assembly, which has superior waterproofness.

A further objective of the present invention is to provide a LED lamp assembly, wherein the inner and outer surfaces of the heat-dissipating cup of the LED lamp has tiny embossed patterns formed via sand blasting and anodizing, whereby the heat generated by the LED lamp can be fast dissipated without using the conventional heat-dissipating fins, and whereby the present invention has advantages of compactness, lightweight, simple structure and low fabrication cost, and whereby the anodized inner and outer surfaces of the heat-dissipating cup has corrosion- and weathering-resistance.

To achieve the abovementioned objectives, the present invention proposes a LED lamp assembly, which comprises a lamp casing having a set of separator fixing protrusions arranged on the inner surface and a set of panel fixing protrusions arranged on the inner surface and below the separator fixing protrusions; a lamp fixing separator arranged inside the lamp casing and used to fix at least one LED lamp, wherein the rim of the lamp fixing separator is fixed to the separator fixing protrusions; and a panel arranged inside the lamp casing and having at least one opening allowing the bottom of the LED lamp to pass, wherein the rim of the panel is fixed to the panel fixing protrusions.

Below, the embodiments are described in detail in cooperation with the drawings to make easily understood the technical contents and efficacies of the present invention.

### BRIEF DESCRIPTION OF THE DRAWINGS

FIG. 1a is a sectional view and a bottom view of a LED lamp assembly according to the present invention;

FIG. 1b is a bottom view of a LED lamp assembly according to the present invention;

FIG. 1c is a sectional view of a LED lamp assembly without LED lamps according to the present invention;

FIG. 1d is a side view of a LED lamp according to the present invention;

FIG. 2 is a perspective view schematically showing that a LED lamp assembly is assembled to a street light pole according to the present invention;

FIG. 3 is a diagram schematically showing that six LED lamps are used to form a disc-shape LED lamp assembly according to one embodiment of the present invention;

FIG. 4 is a diagram schematically showing that six LED lamps are used to form a rectangular-shape LED lamp assembly according to another embodiment of the present invention; and

FIG. 5 is a diagram schematically showing that nine LED lamps are used to form a square-shape LED lamp assembly according to a further embodiment of the present invention.

### DETAILED DESCRIPTION OF THE INVENTION

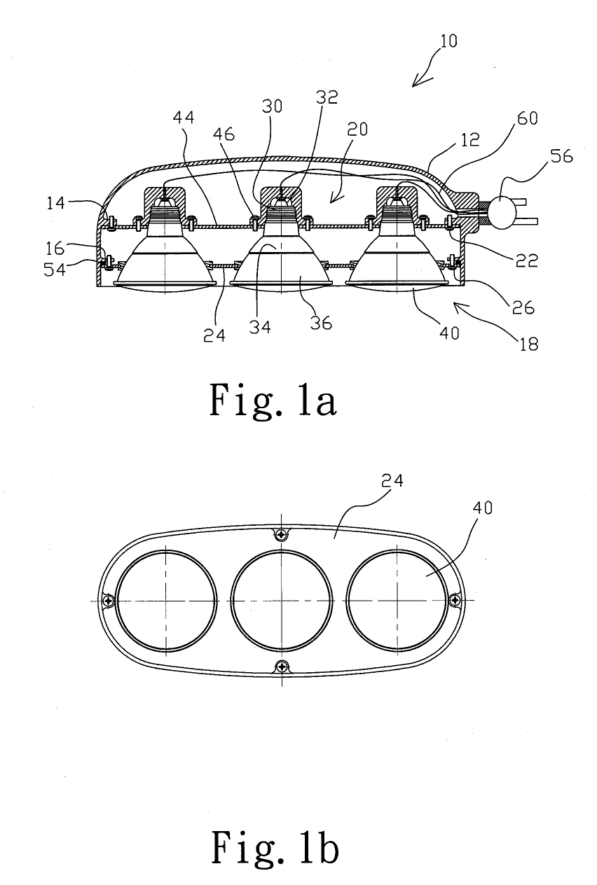

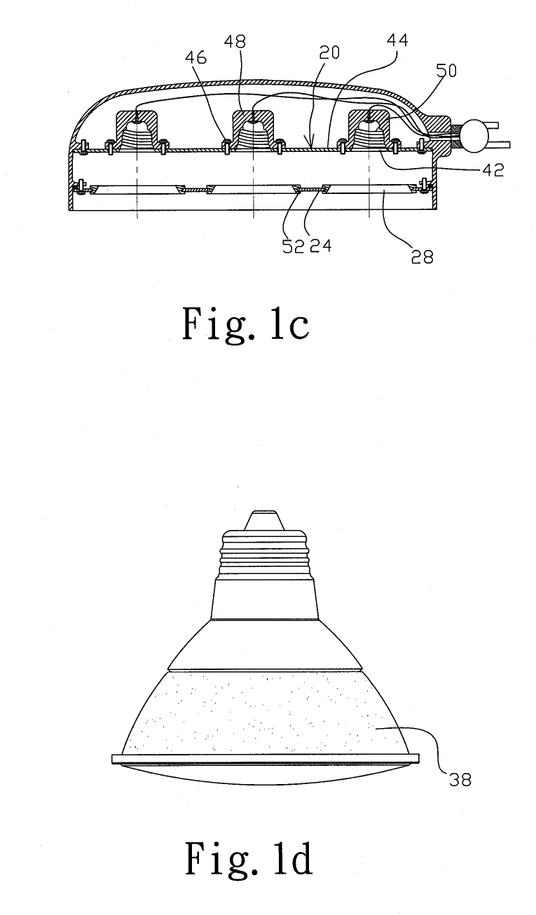

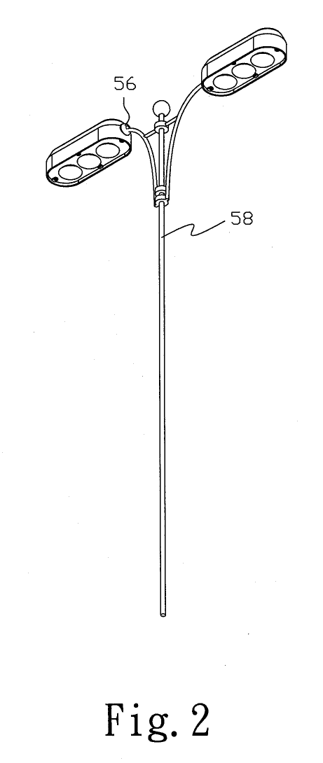

Refer to FIGS. 1a-1d and FIG. 2. FIG. 1a and FIG. 1b are respectively a sectional view and a bottom view of a LED lamp assembly according to the present invention. FIG. 1c is a sectional view of a LED lamp assembly without LED lamps according to the present invention. FIG. 1d is a side view of a LED lamp according to, the present invention. FIG. 2 is a perspective view schematically showing that a LED lamp assembly is assembled to a street light pole according to the present invention. The LED lamp assembly 10 of the present invention comprises a lamp casing 12 having a set of separator fixing protrusions 14 arranged on the inner surface thereof and a set of panel fixing protrusions 16 arranged on the inner surface thereof and below the separator fixing protrusions 14; a lamp fixing separator 20 arranged inside the lamp casing 12 and used to fix LED lamps 18, wherein the rim of the lamp fixing separator 20 is fixed to the separator fixing protrusions 14 via screws 22; and a panel 24 arranged inside the lamp casing 12 and having openings 28 allowing the bottoms of the LED lamps 18 to pass, wherein the rim of the panel 24 is fixed to the panel fixing protrusions 16 via screws 26.

The LED lamp 18 includes a lamp head 32, an insulating pipe 34, a heat-dissipating cup 36, and a lamp cover 40. The lamp head 32 has a thread 30 on the surface thereof. Two ends of the insulating pipe 34 are respectively coupled to the lamp head 32 and the heat-dissipating cup 36. The outer and inner surfaces of the heat-dissipating cup 36 have tiny embossed patterns 38 formed with sand blasting and anodizing. The bottom of the heat-dissipating cup 36 has a LED circuit board (not shown in the drawings), and at least one high-power LED is arranged on the LED circuit board. The lamp cover 40 covers the heat-dissipating cup 36.

The tiny embossed patterns 38, which are formed with sand blasting and anodizing, can increase the surface area of the heat-dissipating cup 36 and rapidly dissipate the heat generated by high-power LED. Therefore, the present invention needn't use the conventional heat-dissipating fins and has advantages of compactness, lightweight, simple structure and low cost. As the inner and outer surfaces of the heat-dissipating cup 36 are anodized, they are corrosion-resistant and weathering-resistant.

A heat-resistant and waterproof plastic ring (not shown in the drawings) is arranged between the insulating pipe 34 and the heat-dissipating cup 36. There is also a heat-resistant and waterproof plastic ring (not shown in the drawings) arranged between the heat-dissipating cup 36 and the lamp cover 40. Thereby, humidity cannot enter the LED lamp 18.

The lamp fixing separator 20 includes a separating board 44 having insertion holes 42 and includes lamp seats 48 each hooding the insertion hole 42 and fixed to the separating board 44 neighboring the insertion hole 42 with screws 46. The inner surface of the lamp seat 48 has a second thread 50 corresponding to the first thread 30 of the lamp head 32. Thus, the LED lamp 18 is inserted upward through the opening 28 and the insertion hole 42 in sequence and then installed in the lamp seat 48 via screwing the first thread 30 of the lamp head 32 into the second thread 50 of the lamp seat 48.

A first waterproof plastic ring 52 is arranged on the panel 24 around the opening 28 and tightly contacts the outer surface of the heat-dissipating cup 36. There is also a second waterproof ring 54 arranged between the panel 24 and the panel fixing protrusions 15 to achieve the same objective.

The lamp casing 12 also has a connector 56 to connect with a street light pole 58, as shown in FIG. 2. The LED lamp assembly 10 further comprises a power cord 60. One end of the power cord 60 is passed through the connector 56 and the lamp seat 48 to connect with the LED lamp 18, and the other end is connected to a power source (not shown in the drawings).

Distinct from the conventional technology, the breakdown LED lamp 18 can be easily replaced via screwing the lamp head 32 out of the lamp seat 48 in the present invention. When the circuit of the LED lamp assembly 10 malfunctions, the lamp fixing separator 20 and the panel 24 can be easily disassembled from the separator fixing protrusions 14 and the panel fixing protrusions 16 via screwing the screws 22 and 26 to facilitate the maintenance of the internal circuit.

The LED lamp 18 used in the present invention has the advantages of small volume, lightweight, corrosion- and weathering-resistance, simple structure, and low cost, which can effectively reduce the weight and cost of the LED lamp assembly 10 and benefit the outdoor application of the LED lamp assembly 10.

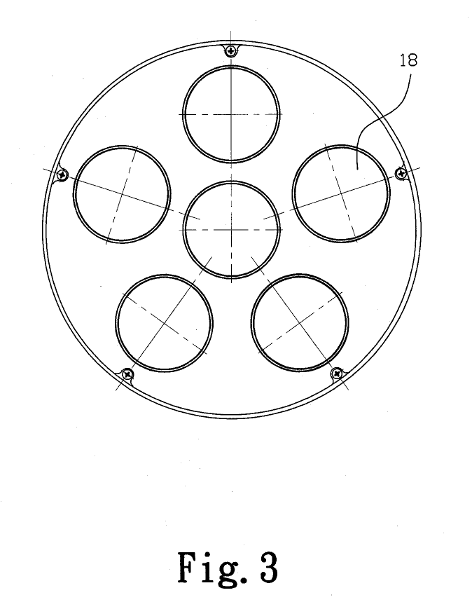

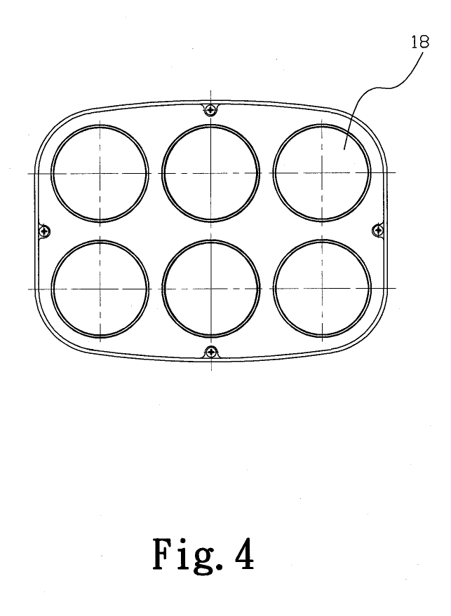

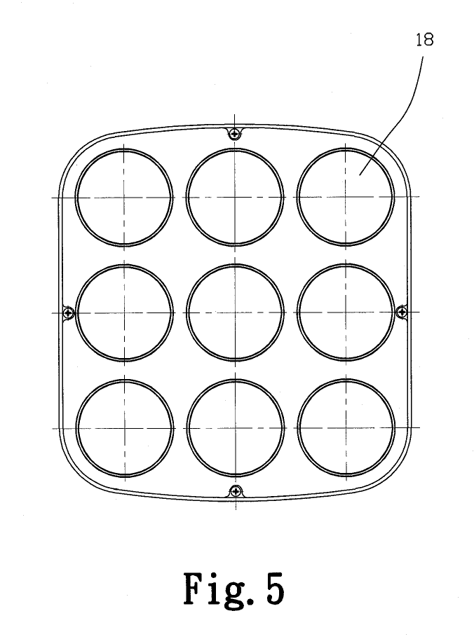

As the LED lamps 18 used in the present invention are compact and lightweight, the number and arrangement of the LED lamps 18 can be flexibly adjusted according to the requirement of illumination. In FIG. 1b, three LED lamps 18 are used to form an elliptic-shape LED lamp assembly, which is adapted to an 80-260V AC power source and able to generate a 36 W illumination. In FIG. 3, six LED lamps 18 are used to form a disc-shape LED lamp assembly generating a 72 W illumination. In FIG. 4, six LED lamps 18 are used to form a rectangular-shape LED lamp assembly. In FIG. 5, nine LED lamps 18 are used to form a square-shape LED lamp assembly generating a 108 W illumination.

The LED lamp assembly of the present invention has superior waterproofness. Therefore, the present invention also applies to projection lamps, garden lamps and decoration lamps in addition to street lights.

The embodiments described above are only to exemplify the present invention but not to limit the scope of the present invention. Any equivalent modification or variation according to the spirit and technical characteristics of the present invention is to be also included within the scope of the present invention.

What is claimed is:

1. A light emitting diode lamp assembly comprising
a lamp casing having a set of separator fixing protrusions arranged on an inner surface thereof and a set of panel fixing protrusions arranged on said inner surface and below said separator fixing protrusions;
a lamp fixing separator arranged inside said lamp casing and used to fix at least one LED (Light-Emitting Diode) lamp, wherein a rim of said lamp fixing separator is fixed to said separator fixing protrusions; and
a panel arranged inside said lamp casing and having at least one opening allowing a bottom of said LED lamp to pass, wherein a rim of said panel is fixed to said panel fixing protrusions.

2. The light emitting diode lamp assembly according to claim 1, wherein said lamp fixing separator further comprises
a separating board having at least one insertion hole; and
at least one lamp seat hooding said insertion hole and fixed to a region of said separating board, which is around said insertion hole, wherein a top end of said LED lamp is inserted through said insertion hole and fixed to said lamp seat.

3. The light emitting diode lamp assembly according to claim 2, wherein said LED lamp further comprises
a lamp head fixed to said lamp seat;
an insulating pipe with one end thereof fixed to said lamp head in a screwing way;
a heat-dissipating cup installed on another end of said insulating pipe, having tiny embossed patterns on an inner surface and an outer surface thereof and partially protruding from said opening; and
a lamp cover covering said heat-dissipating cup.

4. The light emitting diode lamp assembly according to claim 3, wherein a first waterproof plastic ring is arranged on a region of said panel, which is around said opening, and tightly contacts said outer surface of said heat-dissipating cup.

5. The light emitting diode lamp assembly according to claim 2, wherein said lamp casing further comprises a connector for connecting with a street light pole.

6. The light emitting diode lamp assembly according to claim 5 further comprising a power cord , wherein one end of said power cord passes through said connector and said lamp seat to connect with said LED lamp.

7. The light emitting diode lamp assembly according to claim 3, wherein said tiny embossed patterns are formed via sand blasting and anodizing.

8. The light emitting diode lamp assembly according to claim 1, wherein a second waterproof ring is arranged between said rim of said panel and said panel fixing protrusions.

9. The light emitting diode lamp assembly according to claim 1, wherein three said LED lamps are used to form an elliptic-shape LED lamp assembly; alternatively, six said LED lamps are used to form a circular-shape or rectangular-shape LED lamp assembly; alternatively, nine said LED lamps are used to form a square-shape LED lamp assembly.
